(19) United States
(12) Patent Application Publication
(10) Pub. No.: US 2007/0046198 A1
(43) Pub. Date: Mar. 1, 2007

(54) ORGANIC ELECTROLUMINESCENT DEVICE, COVER PLATE OF ORGANIC ELECTROLUMINESCENT DEVICE, AND METHOD FOR FABRICATING COVER PLATE

(76) Inventors: Yung-Chia Kuan, Taipei City (TW); Wei-Jen Tai, Chiayi County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/161,993

(22) Filed: Aug. 25, 2005

(51) Int. Cl. H05B 33/04

(52) U.S. Cl. 313/512

(57) ABSTRACT

A method for fabricating a cover plate of an organic electroluminescent device comprising the following steps is provided. First, a substrate is provided, wherein the substrate has a bonding region. Then, a liquid-state desiccant layer is formed on the substrate, wherein the liquid-state desiccant layer is surrounded by the bonding region. Next, the liquid-state desiccant layer is cured to form a desiccant layer. Then, the bonding region of the substrate is cleaned. As mentioned above, the contaminants on the bonding region can be drastically reduced. Moreover, an organic electroluminescent device and a cover plate thereof are also provided.

### BACKGROUND OF THE INVENTION

1. Field of the Invention

The present invention generally relates to a light-emitting device. More particularly, the present invention relates to an organic electroluminescent device, a cover plate of the organic electroluminescent device, and a method for fabricating the cover plate.

2. Description of Related Art

Organic electroluminescent device (OELD) utilizes the self-illuminating property of an organic functional material to illuminate an image. According to the molecular weight of the organic functional material, the OELD can be classified into small molecule organic electroluminescent device (SM-OELD) and polymer electroluminescent device (PELD). The light-emitting structure of both types of OELD comprises a pair of electrodes and an organic functional material layer sandwiched between the two. When a DC voltage is applied to the electrodes, holes are injected from the anode into the organic functional material layer while electrons are injected from the cathode into the organic functional material layer. Due to the potential produced by an external electric field, hole and electron carriers moving inside the organic functional material layer may collide and recombine with each other. A portion of the energy released by the recombination of electron-hole pairs may excite the organic functional molecules into an excited state. When an excited molecule releases its energy and falls back to a ground state, a definite portion of the energy is released as photons. Hence, the organic electroluminescent device (OELD) will emit light on activation.

In general, since the organic functional material layer is easily deteriorated in presence of moisture, a desiccant layer is formed on a cover plate of the organic electroluminescent device. The conventional method for fabricating the cover plate, for example, forms a liquid-state desiccant layer within a concave of the substrate first, and then cures the liquid-state desiccant layer to form the desiccant layer. It should be noted that, in the process of curing the liquid-state desiccant layer, a solvent used in the liquid-state desiccant layer may remain not only in a processing apparatus but on a bonding region of the cover plate. The solvent remaining on the bonding region of the cover plate may reduce the adhesive strength between the cover plate and a device substrate. In other words, the apparatus must be cleaned after performing the fabricating process in predetermined times.

### SUMMARY OF THE INVENTION

Accordingly, the present invention is directed to a method for fabricating a cover plate of an organic electroluminescent device to reduce the frequency of cleaning the curing apparatus.

In addition, the present invention is directed to a cover plate of an organic electroluminescent device, which provides superior water absorptivity.

Furthermore, the present invention is directed to an organic electroluminescent device, which has superior adhesive strength between the cover plate and the device substrate.

The present invention provides a method for fabricating a cover plate of an organic electroluminescent device comprising the following steps. First, a substrate is provided, wherein the substrate has a bonding region. Then, a liquid-state desiccant layer is formed on the substrate, wherein the liquid-state desiccant layer is surrounded by the bonding region. Next, the liquid-state desiccant layer is cured to form a desiccant layer. Then, the bonding region of the substrate is cleaned.

The present invention provides a cover plate of an organic electroluminescent device. The cover plate comprises a substrate and a desiccant layer. Wherein, the substrate has a bonding region, and the desiccant layer is disposed on the substrate and surrounded by the bonding region. In addition, the desiccant layer has a rough surface.

The present invention provides an organic electroluminescent device, which comprises a device substrate, a cover plate, and a sealant. Wherein, the device substrate has a device layer disposed thereon, and the cover plate is disposed over the device substrate for covering the device layer. The cover plate comprises a substrate and a desiccant layer, wherein the substrate has a bonding region, and the desiccant layer is disposed on the substrate and surrounded by the bonding region. In addition, the desiccant layer has a rough surface, and the sealant is disposed between the device substrate and the bonding region of the cover plate.

Since the bonding region of the substrate is cleaned after the desiccant layer is formed, the present invention provides higher adhesive strength between the cover plate and the sealant. In addition, the desiccant layer has the rough surface for providing superior water absorptivity.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A through 1E are schematic views illustrating a method for fabricating an organic electroluminescent device according to a preferred embodiment of the present invention.

FIG. 2 is a schematic view illustrating an organic electroluminescent device according to a preferred embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

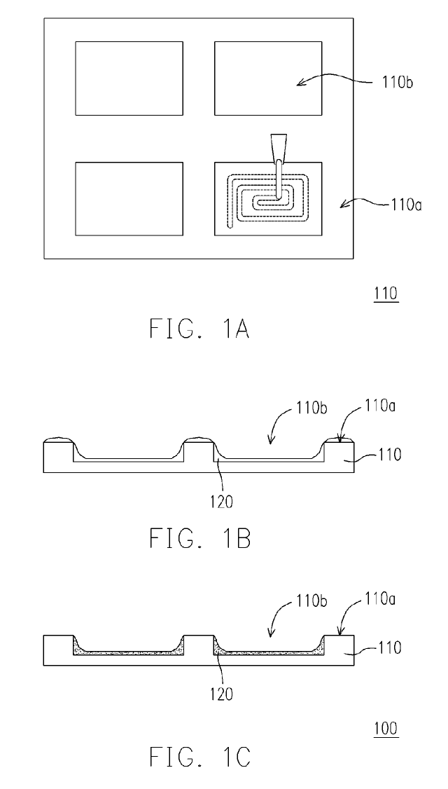

FIG. 1A through 1E is schematic views illustrating a method for fabricating an organic electroluminescent device according to a preferred embodiment of the present invention. Referring to FIG. 1A, a substrate 110 is provided, wherein the material of the substrate 110 may be glass or metal. In addition, the substrate 110 has a concave 110b and a bonding region 110a surrounding the concave 110b. It should be noted that a cleaning process can be selectively performed first, wherein the cleaning process may comprise the steps of wet cleaning, vacuum drying, and dry cleaning in sequence. The step of dry cleaning is performed by using oxygen plasma or excimer laser.

Then, a liquid-state desiccant layer is formed within the concave 110b of the substrate 110. For example, a liquid-state desiccant material is filled into the concave 110b in a manner of dropping, and then the liquid-state desiccant material will spread within the concave 110b to form the liquid-state desiccant layer. The liquid-state desiccant layer comprises solute and solvent, wherein the solvent may be organic solute, and the solute may be barium oxide, calcium oxide, barium sulfate, or calcium sulfate.

Referring to FIG. 1B, the liquid-state desiccant layer is cured to form a desiccant layer 120. Specifically, since the organic solvent of the liquid-state desiccant layer has a lower boiling point, the liquid-state desiccant layer in the concave 110b can be heated to form the desiccant layer 120 having a smooth surface. It should be noted that the organic solvent of the liquid-state desiccant layer also remains on the bonding region 110a as the liquid-state desiccant layer is cured.

Referring to FIG. 1C, in order to remove the residue (organic solvent) on the bonding region 110a, a cleaning process is performed to the substrate 110 by using such as plasma or excimer laser. The plasma may be oxygen plasma, nitrogen plasma, argon plasma, or other suitable plasma, and the excimer laser may be ultraviolet (UV) excimer laser, or other suitable excimer laser.

After the cleaning process, a wetting angle of the bonding region is usually smaller than 35°. It should be noted that the embodiment is not limited to clean only the bonding region 110a. For simplifying the process, the plasma or the excimer laser is usually applied to the whole substrate 110, thus the original smooth surface of the desiccant layer 120 is turned into a rough surface. Unlike the prior art, the desiccant layer 120 has the rough surface for providing superior water absorptivity.

In addition, the steps of curing the liquid-state desiccant layer and cleaning the substrate 110 can be performed not only in different chambers, but in the same chamber. In other words, the steps of curing the liquid-state desiccant layer and cleaning the substrate 110 may be performed through an in-situ process.

Referring to FIG. 1D, a device substrate 200 having a plurality of island device layers 210 disposed thereon is provided. Then, a sealant 300 is formed on the bonding region 110a of the cover plate 100 or on the device substrate 200, wherein the material of the sealant 300 may be photo-cured material or thermal-cured material. Next, the cover plate 100 is disposed over the device substrate 200, wherein the sealant 300 is located between the bonding region 110a of the cover plate 100 and the device substrate 200. After that, the sealant 300 is cured. Specifically, according to the material of the sealant 300, the method for curing the sealant 300 comprises applying reaction light or heating, wherein the reaction light may be ultraviolet (UV) light.

Referring to FIG. 1E, the structure formed above can be applied to an organic electroluminescent display. After the sealant 300 is cured, a singulation process is performed to form a plurality of organic electroluminescent device 10. Since the bonding region 110a of the cover plate 100 is cleaned after the liquid-state desiccant layer is cured, the embodiment provides higher adhesive strength between the sealant 300 and the cover plate 100 than the prior art. It should be noted that the desiccant layer 120 has the rough surface for superior water absorptivity. Furthermore, since the bonding region 110a of the cover plate 100 is cleaned, the shutdown frequency of the curing apparatus can be reduced.

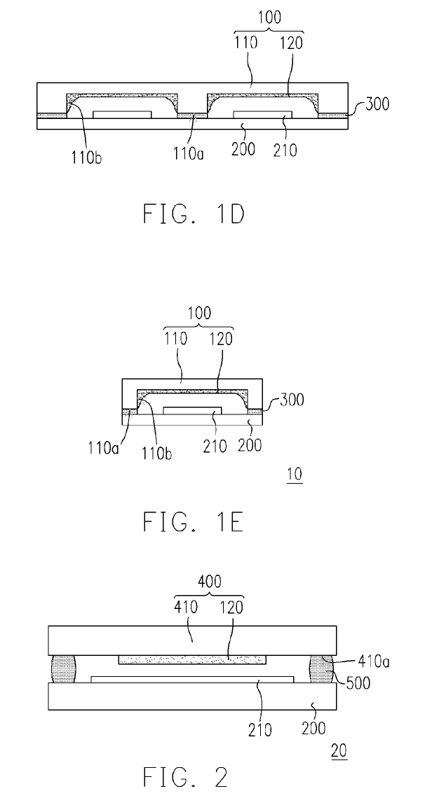

FIG. 2 is a schematic view illustrating an organic electroluminescent device according to a preferred embodiment of the present invention. Referring to FIG. 2, one difference between FIG. 2 and FIG. 1E is that the substrate 410 of the organic electroluminescent device 20 shown in FIG. 2 has no concave. In other words, the cover plate 400 is a flat plate. In the embodiment, the bonding region 410a of the substrate 410 is also cleaned after the desiccant layer 120 is formed. In addition, the sealant 500 is disposed between the bonding region 410a of the substrate 410 and the device substrate 200. The sealant 500 is used for not only sealing, but isolating the device substrate 200 and the cover plate 400. In other words, the sealant 500 is regarded as a spacer.

In summary, the organic electroluminescent device, the cover plate of the organic electroluminescent device, and the method for fabricating the cover plate according to the present invention has the following advantages.

1. The present provides higher adhesive strength between the cover plate and the sealant.

2. Since the desiccant layer has the rough surface for providing superior water absorptivity, the organic electroluminescent device of the present invention has higher reliability.

3. The present invention is compatible with existing processes, thus the organic electroluminescent device having higher reliability can be easily fabricated without any additional processing apparatus.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for fabricating a cover plate of an organic electroluminescent device, comprising:
providing a substrate, wherein the substrate has a bonding region;
forming a liquid-state desiccant layer on the substrate, wherein the liquid-state desiccant layer is surrounded by the bonding region;
curing the liquid-state desiccant layer to form a desiccant layer; and
cleaning the bonding region of the substrate.

2. The method according to claim 1, wherein a wetting angle of the bonding region is smaller than 35° after the bonding region is cleaned.

3. The method according to claim 1, wherein the surface of the desiccant layer turns rough after the step of cleaning the bonding region of the substrate.

4. The method according to claim 1, wherein the steps of curing the liquid-state desiccant layer and cleaning the bonding region of the substrate are performed through an in-situ process.

5. The method according to claim 1, wherein the step of cleaning the bonding region of the substrate is performed by using plasma or excimer laser.

6. The method according to claim 5, wherein the plasma is oxygen plasma, nitrogen plasma, or argon plasma.

7. The method according to claim 5, wherein the excimer laser is ultraviolet excimer laser.

8. A cover plate of an organic electroluminescent device, comprising:
a substrate, having a bonding region; and
a desiccant layer, disposed on the substrate and surrounded by the bonding region, wherein the desiccant layer has a rough surface.

9. The cover plate according to claim 8, wherein the wetting angle of the bonding region is smaller than 35°.

10. The cover plate according to claim 8, wherein the substrate has a concave for allowing the desiccant layer being disposed therein.

11. The cover plate according to claim 8, wherein the material of the substrate is glass or metal.

12. The cover plate according to claim 8, wherein the material of the desiccant layer is barium oxide, calcium oxide, barium sulfate, or calcium sulfate.

13. An organic electroluminescent device, comprising:
a device substrate, having a device layer disposed thereon;
a cover plate, disposed over the device substrate for covering the device layer, wherein the cover plate comprises:
a substrate, having a bonding region;
a desiccant layer, disposed on the substrate and surrounded by the bonding region,
wherein the desiccant layer has a rough surface; and
a sealant, disposed between the device substrate and the bonding region of the cover plate.

14. The organic electroluminescent device according to claim 13, wherein the wetting angle of the bonding region is smaller than 35°.

15. The organic electroluminescent device according to claim 13, wherein the substrate has a concave for allowing the desiccant layer being disposed therein.

16. The organic electroluminescent device according to claim 13, wherein the material of the substrate is glass or metal.

17. The organic electroluminescent device according to claim 13, wherein the material of the desiccant layer is barium oxide, calcium oxide, barium sulfate, or calcium sulfate.

18. The organic electroluminescent device according to claim 13, wherein the material of the sealant is photo-cured material or thermal-cured material.
